(19) United States
(12) Patent Application Publication
(10) Pub. No.: US 2004/0182440 A1
(43) Pub. Date: Sep. 23, 2004

(54) Exhaust pipe valve

(76) Inventors: Lee Watts, Gersthofen (DE); Andrew Hogg, Cottam (GB); Phillip Bush, Lincoln (GB)

Correspondence Address: CARLSON, GASKEY & OLDS, P.C., 400 WEST MAPLE ROAD, SUITE 350, BIRMINGHAM, MI, 48009, US

(21) Appl. No.: 10/775,033

(22) Filed: Feb. 9, 2004

(30) Foreign Application Priority Data
Feb. 17, 2003 (DE) 203 02 520.2

(51) Int. Cl. F16L 7/00

(52) U.S. Cl. 137/375

(57) ABSTRACT

An exhaust pipe valve has a housing, a bearing sleeve mounted in the housing, a valve spindle rotatably mounted in the bearing sleeve, and a valve plate mounted at the valve spindle. The bearing sleeve has a primary bearing surface on its side facing the valve plate, and the valve spindle has a primary sealing surface that cooperates with the primary bearing surface of the bearing sleeve. A washer is arranged on the valve spindle and cooperates with the bearing sleeve on a side facing away from the valve plate. A spring biases the primary sealing surface of the valve spindle against the primary bearing surface of the bearing sleeve while biasing the washer against the bearing sleeve.

### REFERENCE TO RELATED APPLICATIONS

The present invention claims the benefit of German Patent Application No. 203 02 520.2, filed Feb. 17, 2003.

### TECHNICAL FIELD

The invention relates to exhaust pipe valves.

### BACKGROUND OF THE INVENTION

Exhaust pipe valves are used in many applications, such as emissions, engine performance, acoustics and heat management. For illustrative purposes only, the description below will describe an exhaust pipe valve that is used for controlling exhaust gas flow through an exhaust gas heat exchanger as is used for an auxiliary heating system. Those of skill in the art will understand, however, that the exhaust pipe valve of the invention is not limited to such an application.

Auxiliary heating systems are increasingly used in vehicles having modern combustion engines with low fuel consumption. Due to their high efficiencies, these combustion engines produce only a small amount of lost heat, reducing the supply of heat available for the heating system for the vehicle. This results in reduced heating performance of the heating system, creating potential discomfort for the vehicle occupants. Accordingly, systems using a heat exchanger arranged in the exhaust system of the vehicle have been developed to overcome this problem. The heat exchanger allows gain in a certain proportion of the heat of the exhaust gas, which is then is available for heating the interior of the vehicle.

These types of systems typically have an exhaust gas duct in which the heat exchanger is arranged and a bypass duct. By controlling the proportion of the overall exhaust gas flowing through the heat exchanger duct, the system can create a desired heating characteristic of the system. To this end, the exhaust pipe valve can be controlled according to external parameters.

FIGS. 1 and 2 illustrate two general system environments. In both environments, the exhaust gas enters in the direction of arrow P from the right side with respect to the drawings.

The system includes a heat exchanger duct 5 with a heat exchanger 7 for the exhaust gas and a bypass duct 9. An exhaust pipe valve 10 controls the flow of the exhaust gas through the heat exchanger duct 5 and the bypass duct 9.

In the environment shown in FIG. 1, the proportion of gas flow through the ducts is controlled by varying the flow resistance of the bypass duct 9. When the valve 10 is in its completely opened position, the flow resistance of the bypass duct 9 is significantly less than the flow resistance of the heat exchanger 7 in the heat exchanger duct 5. This results in almost no gas flow through the heat exchanger 7. Conversely, when the valve 10 is in its completely closed position, the gas flow through the bypass duct 9 is blocked, and the gas flows completely through the heat exchanger 7, apart from a small leakage flow past the valve 10. Controlling the position of the valve 10 in intermediate positions makes it possible to obtain any desired proportion of gas flow through both ducts.

In the system environment shown in FIG. 2, the gas flow is controlled directly by operating the valve 10 so that the inlet opening of the heat exchanger duct 5 or the bypass duct 9 is opened or closed. Here again, intermediate positions of the valve 10 makes it possible to obtain any desired proportion of the gas flow through the ducts.

Currently known valves used for controlling the exhaust gas flow through the ducts pose two main problems, however. First, the valves must withstand high operating temperatures and sharp increases in operating temperatures while still having a part lifetime of 10 to 15 years. Second, the valves must prevent any leakage of exhaust gas from the exhaust gas side of the valve toward the exterior because the valves are typically employed upstream of a catalytic converter, where the leaking exhaust gas has not yet been purified.

Even if the valve is used in other applications, such as diesel heat recovery systems where no catalytic converter is used, leakage prevention still has high importance due to other operational factors such as, for instance, acoustic performance and thermal management.

There is a desire for an exhaust pipe valve that is reliable, has a long lifetime, that minimizes leakage of exhaust gas.

### SUMMARY OF THE INVENTION

The invention is generally directed to an exhaust pipe valve having a housing, a bearing sleeve mounted in the housing, a valve spindle rotatably mounted in the bearing sleeve, and a valve plate mounted at the valve spindle. The bearing sleeve has a primary bearing surface on the side facing the valve plate. The valve spindle has a primary sealing surface that cooperates with the primary bearing surface of the bearing sleeve. A washer is arranged on the valve spindle to cooperate with the bearing sleeve on the side facing away from the valve plate, and a spring biases the primary sealing surface of the valve spindle against the primary bearing surface of the bearing sleeve while biasing the washer against the bearing sleeve.

In one embodiment, a secondary bearing surface is formed on the side of the bearing sleeve facing away from the valve plate, and a secondary sealing surface is formed on the washer to cooperate with the secondary bearing surface. Providing the sealing surfaces and the bearing surfaces on both sides of the bearing sleeve improves the sealing effect and the stability of the bearing. The sealing surface may be formed on a radially projecting shoulder formed integrally with the valve spindle.

In one embodiment of the invention, the spring is arranged between a nut mounted on the valve spindle and the washer. Because there is no relative movement between the nut and the washer, friction losses occurring during rotation of the valve spindle are kept low.

Further, the spring compensates for thermal expansion of the components of the valve occurring during operation.

According to one embodiment of the invention, the bearing sleeve is mounted in the housing via a press-fit, preferably in the interior of a cylindrical portion of the housing. The press-fit eliminates the need for additional structures to position or hold the bearing sleeve, structures that may otherwise present problems with respect to thermal expansion.

The inventive valve therefore has a simple construction, improving longevity and reliability. The bearing sleeve acts as both a seal against leakage of exhaust gas towards the exterior and as a bearing in which the valve spindle is rotatably mounted.

### BRIEF DESCRIPTION OF THE DRAWINGS

The invention will hereinafter be described by means of a preferred embodiment which is shown in the enclosed drawings. In the drawings,

FIG. 1 is a representative diagram of an exhaust gas heat exchanger system environment employing a valve;

FIG. 2 is a representative diagram of another exhaust gas heat exchanger system environment employing a valve;

FIG. 3 is an exploded view of a valve according to one embodiment of the invention that can be used in the system environment of FIG. 1;

FIG. 4 is a sectional view of a valve according to one embodiment of the invention that can be used in the system environment of FIG. 2;

FIG. 5 is another sectional view of the valve shown in FIG. 4; and

FIGS. 6 to 9 schematically show a process of mounting the valve into the system environment.

### DETAILED DESCRIPTION OF THE EMBODIMENTS

The invention is generally directed to an exhaust pipe valve having a housing, a bearing sleeve mounted in the housing, a valve spindle rotatably mounted in the bearing sleeve, and a valve plate mounted at the valve spindle. The bearing sleeve has a primary bearing surface on the side facing the valve plate. The valve spindle has a primary sealing surface that cooperates with the primary bearing surface of the bearing sleeve. A washer is arranged on the valve spindle to cooperate with the bearing sleeve on the side facing away from the valve plate. A spring biases the primary sealing surface of the valve spindle against the primary bearing surface of the bearing sleeve while biasing the washer against the bearing sleeve.

The inventive valve therefore has a simple construction, improving valve longevity and reliability. The bearing sleeve acts as both a seal against leakage of exhaust gas towards the exterior and as a bearing in which the valve spindle is rotatably mounted.

In one embodiment, a secondary bearing surface is formed on the side of the bearing sleeve facing away from the valve plate, and a secondary sealing surface is formed on the washer to cooperate with the secondary bearing surface. Providing the sealing surfaces and the bearing surfaces on both sides of the bearing sleeve improves the sealing effect and the stability of the bearing.

In one embodiment, the sealing surfaces and the bearing surfaces are conical. This allows precise centering of the valve spindle within the bearing sleeve and also improves the sealing characteristics of the valve.

According to one embodiment of the invention, the spring is arranged between a nut mounted on the valve spindle and the washer. The spring may be a spring washer made from a nickel-chromium-iron alloy, such as INCONEL. Because there is no relative movement between the nut and the washer in the valve, friction losses occurring during rotation of the valve spindle are kept low. Further, the spring compensates for thermal expansion of the components of the valve occurring during operation. The spring may be designed so that the biasing force provided by the spring remains essentially constant over the entire range of operating temperatures. The material of the spring is chosen such that the spring characteristic is not affected by the operating temperatures of the valve.

According to one embodiment of the invention, the valve spindle is made from a material offering good heat resistance such as, for example, steel with Werkstoff No. 1.4122 or 1.4104. In one embodiment, the sealing surface formed on the valve spindle is formed on a radially projecting shoulder formed integrally with the valve spindle.

In order to improve the sealing qualities between the valve spindle and the bearing sleeve, the valve spindle may at least be partially provided with a ceramic coating. The coating is disposed on at least on the primary sealing surface of the valve spindle. The ceramic coating ensures that the valve spindle can be rotated relative to the bearing sleeve over a long lifetime and under high operating temperatures which may be in the region of up to 800° C. At the same time, the ceramic coating has a low surface roughness, resulting in good sealing properties. The ceramic coating may contain titanium (Ti), aluminum (Al) and/or chromium (Cr). Additionally, yttrium (Y) and nitrogen (N) may be present in the ceramic coating. Still further, a second ceramic coating containing Ti, Al and/or N may be provided over the first coating.

Depending on constructional preconditions, the valve plate may be mounted centrically or eccentrically at the valve spindle. In any case, the valve spindle is preferably supported on only one side of the valve plate, resulting in low frictional losses and less strict requirements with respect to tolerances because the invention does not require two bearings to be concentrically arranged on either side of the valve plate. In case higher loads act on the valve spindle, a second bearing on the opposite side of the valve plate may be used to handle the higher loads.

According to one embodiment of the invention, the bearing sleeve is mounted in the housing via a press-fit, preferably in the interior of a cylindrical portion of the housing. The press-fit eliminates the need for additional structures to position or hold the bearing sleeve, structures that may otherwise present problems with respect to thermal expansion. A particularly suitable material for the bearing sleeve is steel with Werkstoff No. 1.4122 or 1.4104.

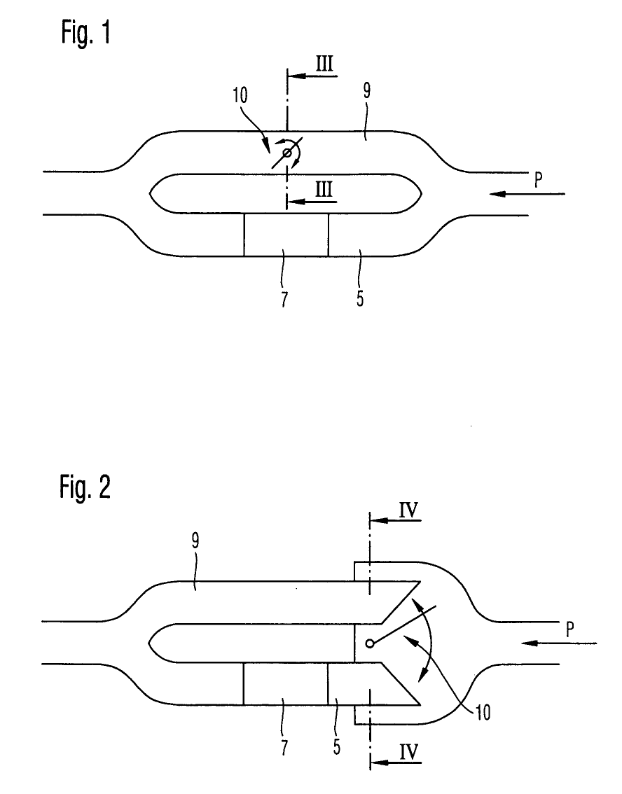

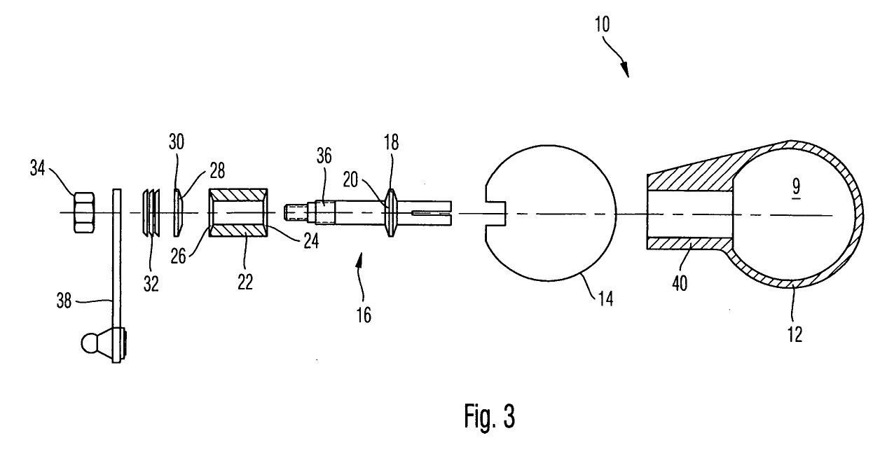

FIG. 3 shows an exploded view of a valve according to one embodiment of the invention. The valve shown in FIG. 3 can be employed in the system environment shown in FIG. 1. In the illustrated embodiment, the valve comprises a housing 12, which includes a portion of the bypass duct 9 in the system environment. A valve plate 14 is rotatably mounted in the interior of the housing 12. The contour of the valve plate 14 corresponds to the inner contour of the bypass duct 9 in the housing 12.

The valve plate 14 is attached to a valve spindle 16 formed from heat-resistant steel, such as steel with Werkstoff No. 1.4122 or 1.4104. For the valve plate, steel with Werkstoff No. 1.4301 is particularly suitable. The valve spindle 16 comprises a radial shoulder 18 formed integrally with the valve spindle 16. The shoulder 18 has a conical sealing surface 20 on the side facing away from valve plate 14.

The valve spindle 16 is rotatably mounted within a bearing sleeve 22 formed from steel with Werkstoff No. 1.4122 or 1.4104. On its side facing shoulder 18, the bearing sleeve 22 has a conical bearing surface 24. The inclination of the bearing surface 24 corresponds to the inclination of the sealing surface 20. In one embodiment, the bearing surface 24 and the sealing surface 20 form an angle of approximately 20° with a radially extending plane.

A coating may be deposited on the shoulder 16, particularly in the region of sealing surface 20. This coating may be made from a ceramic material comprising at least one of Ti, Al, Cr, Y and N. Over this first coating, a second coating is provided containing Ti, Al and N. These coatings provide a smooth, durable surface so that the cooperation of the sealing surface 20 with the bearing surface 24 forms a primary seal that almost entirely prevents any leakage of exhaust gas through the valve.

On the side facing away from the valve plate 14, the bearing sleeve 22 is provided with a secondary bearing surface, which may have a conical profile like the bearing surface 24. The secondary bearing surface 26 cooperates with a secondary, conical sealing surface 28 formed on a washer 30. The secondary sealing surface 28 also has a conical profile. The washer 30 may be formed from a thermally resistant material, such as steel with Werkstoff No. 1.4122 or 1.4104. The coating described above with respect to the sealing surface 20 can also be deposited on the sealing surface 28 of the washer 30.

A spring washer 32 made from an alloy, such as INCONEL, is arranged on the side of washer 30 facing away from the valve plate 14. A spring washer 32 is compressed by a nut 34 threaded on a thread 36 on valve spindle 16, with an operating lever 38 being arranged between the nut 34 and the spring washer 32. The operating lever 38 may be actuated by a stepper motor or any comparable actuation unit, allowing the operating lever 38 to position valve plate 14 in any desired orientation.

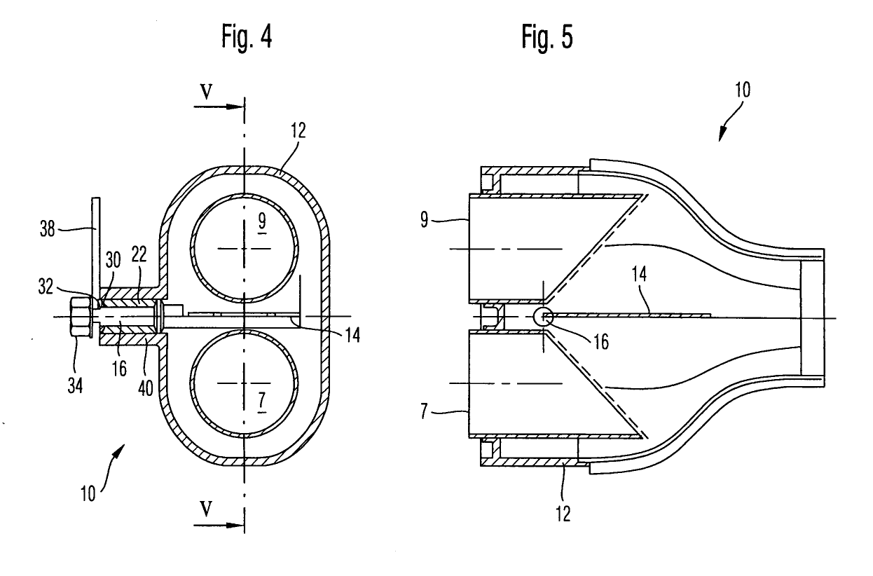

FIGS. 4 and 5 show another embodiment of the inventive valve. The valve structure shown in FIGS. 4 and 5 is similar to the valve structure shown in FIG. 3 with respect to the bearing of the valve spindle 14. The main difference in this embodiment is that valve plate 14 is not essentially circular and mounted centrically to valve spindle 14; instead, the valve plate extends eccentrically from the valve spindle 14 in this embodiment. Both valve structures support the valve plate on only one of its sides. This is possible since bearing sleeve 22 has a certain amount of extension in the axial direction, leading to a comparatively large distance between the primary and the secondary bearing surfaces. This distance provides enough stability to counteract any tilting loads introduced by the valve plate 14 without requiring any additional bearing structure on the opposite side of the valve plate 14.

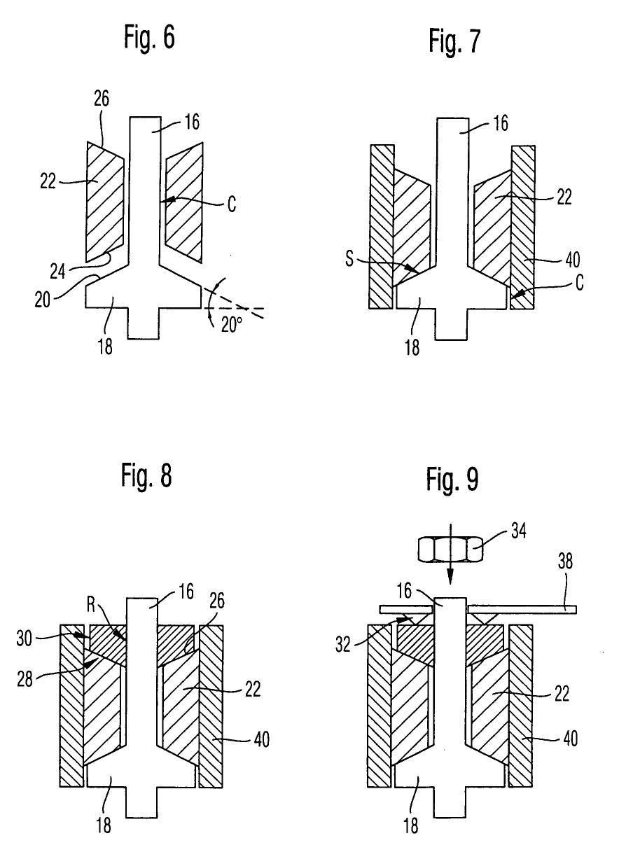

FIGS. 6 to 9 show the steps of mounting a bearing on the valve spindle 16. In a first step shown in FIG. 6, the bearing sleeve 22 is arranged on the valve spindle 16 so that the bearing surface 24 cooperates with the sealing surface 20. In order to prevent seizure, there is a significant clearance C maintained between the inner opening of the bearing sleeve 22 and the valve spindle 16.

In a second step shown in FIG. 7, the bearing sleeve 22 is press-fitted into a cylindrical portion 40 of the housing 12. The dimensions of the cylindrical portion 40 and the bearing sleeve 22 are selected so that there is a press-fit engagement between the bearing sleeve 22 and the housing 12. The friction resulting from the press-fit is sufficient to securely hold the bearing sleeve 22 in place without any additional securing structures. As can be seen in FIG. 7, there is a significant clearance C between the radial shoulder 18 of the valve spindle 16 and the cylindrical portion 40 of the housing 12 to prevent seizure. As can be further seen in FIG. 7, cooperation between the bearing surface 24 and the sealing surface 20 forms a primary seal S, which prevents leakage of exhaust gas from the interior of the housing 12.

In a third step shown in FIG. 8, the washer 30 is mounted on valve spindle 16 such that the secondary sealing surface 28 of the washer 30 cooperates with the secondary bearing surface 26 of the bearing sleeve 22, thereby forming a secondary seal. The washer 30 is dimensioned such that there is a very close running clearance R between the inner opening of the washer 30 and the valve spindle 16. The close clearance R ensures that the valve spindle 16 is correctly centered within the washer 30, thereby ensuring precise positioning of the valve plate 14.

As shown in FIG. 9, the spring washer 32 and the operating lever 38 are mounted on the valve spindle 16, and the nut 34 is tightened enough to preload the spring washer 32.

The preload amount is chosen such that there is a good compromise between low frictional forces between the valve spindle 16 and the bearing sleeve 22 on the one hand and minimal leakage past the primary and secondary seals on the other hand.

It should be understood that various alternatives to the embodiments of the invention described herein may be employed in practicing the invention. It is intended that the following claims define the scope of the invention and that the method and apparatus within the scope of these claims and their equivalents be covered thereby.

1. An exhaust pipe valve, comprising:
a housing;
a bearing sleeve mounted in the housing and having a primary bearing surface;
a valve spindle rotatably mounted in the bearing sleeve and having a primary sealing surface that cooperates with the primary bearing surface of the bearing sleeve;
a valve plate mounted at the valve spindle, wherein the primary bearing surface of the bearing sleeve faces the valve plate;
a washer arranged on the valve spindle, wherein the washer cooperates with the bearing sleeve on a side of the bearing sleeve that faces away from the valve plate; and
a spring that biases the primary sealing surface of the valve spindle against the primary bearing surface of the bearing sleeve while biasing the washer against the bearing sleeve.

2. The exhaust pipe valve according to claim 1, wherein the side of the bearing sleeve that faces away from the valve plate is a secondary bearing surface, and wherein the washer has a secondary sealing surface that cooperates with the secondary bearing surface.

3. The exhaust pipe valve according to claim 2, wherein at least one of the primary sealing surface, the secondary sealing surface, the primary bearing surface and the secondary sealing surface has a conical profile.

4. The exhaust pipe valve according to claim 1, wherein at least one of the primary sealing surface and the primary bearing surface has a conical profile.

5. The exhaust pipe valve according to claim 1, further comprising a nut mounted on the valve spindle, wherein the spring is disposed between the nut mounted on the valve spindle and the washer.

6. The exhaust pipe valve according to claim 5, wherein the spring is a spring washer.

7. The exhaust pipe valve according to claim 1, wherein the spring is made from a nickel-chromium-iron alloy.

8. The exhaust pipe valve according to claim 7, wherein the nickel-chromium-iron alloy is INCONEL.

9. The exhaust pipe valve according to claim 1, wherein the valve spindle is made from steel.

10. The exhaust pipe according to claim 9, wherein the steel has a Werkstoff No. 1.4122 or 1.4104.

11. The exhaust pipe valve according to claim 1, wherein the valve plate is mounted centrically at the valve spindle and cooperates with an inner wall of the housing.

12. The exhaust pipe valve according to claim 1, wherein the valve plate is mounted eccentrically at the valve spindle and cooperates with two valve seats in an interior of the housing.

13. The exhaust pipe valve according to claim 1, further comprising a lever attached to the valve spindle for operation of the valve plate.

14. The exhaust pipe valve according to claim 1, wherein the bearing sleeve is press-fitted into the housing.

15. The exhaust pipe valve according to claim 14, wherein the housing comprises a cylindrical portion in which the bearing sleeve is fitted.

16. The exhaust pipe valve according to claim 1, wherein the bearing sleeve is fixed in the housing in a form-locking manner.

17. The exhaust pipe valve according to claim 1, wherein the bearing sleeve is made from steel.

18. The exhaust pipe valve according to claim 17, wherein the steel has a Werkstoff No. 1.4122 or 1.4104.

19. The exhaust pipe valve according to claim 1, further comprising a ceramic coating disposed on at least a portion of at least one of the valve spindle and the washer.

20. The exhaust pipe valve according to claim 19, wherein the ceramic coating comprises at least one selected from the group consisting of titanium, aluminum, and chromium.

21. The exhaust pipe valve according to claim 20, wherein the ceramic coating further comprises at least one of yttrium and nitrogen.

22. The exhaust pipe valve of claim 19, further comprising a second ceramic coating disposed on the ceramic coating, wherein a second ceramic coating is disposed over the first coating, wherein the second coating comprises at least one selected from the group consisting of titanium, aluminum, and chromium.
